(19) United States
(12) Patent Application Publication
(10) Pub. No.: US 2017/0272498 A1
(43) Pub. Date: Sep. 21, 2017

(54) STREAMING MEDIA FILE DISTRIBUTION METHOD AND SYSTEM

(71) Applicants: LE HOLDINGS (BEIJING) CO., LTD., Beijing (CN); LECLOUD COMPUTING CO., LTD, Beijing (CN)

(72) Inventor: Bin LIU, Beijing (CN)

(21) Appl. No.: 15/246,224

(22) Filed: Aug. 24, 2016

Related U.S. Application Data
(63) Continuation of application No. PCT/CN2016/088897, filed on Jul. 6, 2016.

(30) Foreign Application Priority Data
Mar. 21, 2016 (CN) 201610162594.5

(51) Int. Cl. H04L 29/08; H04L 29/06

(52) U.S. Cl. CPC H04L 67/02; H04L 65/4084; H04L 65/602; H04L 69/16

(57) ABSTRACT

A method and a system are provided for distributing streaming media files. The method includes: acquiring an m3u8 file of a streaming media file; determining an edge server which has a subscription service demand for the m3u8 file; and actively distributing the m3u8 file to the edge server.

### CROSS REFERENCE TO RELATED APPLICATIONS

This application is a continuation of International Application No. PCT/CN2016/088897, filed on Jul. 6, 2016, which is based upon and claims priority to Chinese Patent Application No. 201610162594.5, filed on Mar. 21, 2016, the entire contents of which are incorporated herein by reference.

### TECHNICAL FIELD

Embodiments of the present disclosure relate to the technical field of streaming media, and more particularly to a streaming media file distribution method and system.

### BACKGROUND

An Http live streaming (HLS) protocol is a streaming media transmission protocol realized by Apple Inc. based on the hyper text transport protocol (Http). The HLS protocol partitions continuous media data with huge capacity into numerous small files to transmit, which meets the file transmission requirements of a webpage server. The HLS protocol adopts a continuously updated light index file to control the downloading and play of the partitioned small media files, so as to realize live broadcasting and on-demand broadcasting of stream media. Moreover, the HLS protocol supports automatic conversion of a code rate while prioritizing the smoothness, and is widely used by major video websites.

By the HLS protocol, after processing, video data are partitioned into video clip ts files, and media data index m3u8 files and are stored in a cloud server. Actually, the m3u8 files only are an organizational form of a file group, and used for organizing the video clip ts files together in a form of a play list to allow a multimedia player to download and play. The m3u8 files generally comprise a plurality of uniform resource locators (URL) of video clips. After acquiring the m3u8 files, the multimedia player downloads and plays the corresponding video clips based on the URL therein. A process that a client plays HLS contents is that index files and partitioned files are downloaded separately.

In the prior art, a streaming media play system generally includes a central server and a plurality of edge servers. A client needs to query the latest m3u8 file from the edge servers to obtain the latest playing message. Typically, the central server requires issuing m3u8 files to the edge servers. Basically, issuing streaming media files mainly includes the following steps: firstly, the m3u8 files and video clip ts files are made, and the m3u8 files are stored in the central server; secondly, the edge servers continually poll the center server to acquire the latest m3u8 file and video clip ts file; and finally, the client polls the edge servers to acquire the latest m3u8 file and plays a corresponding streaming media file.

However, during the implementation of the present disclosure, the inventor finds that a method for acquiring a streaming media file via polling among all servers to pull an m3u8 file in the prior art has the following disadvantages: 1), a polling interval exists when edge servers poll a central server to download and update an m3u8 file, so a delay during updating of the m3u8 file by the edge servers becomes longer; 2) as the edge servers do not know the updating time of the m3u8 file in the central server, network bandwidth resources are wasted when the edge servers poll the central server blindly; 3), if the number of requests received by the edge servers is increased, polling times of the edge servers to the central server will be increased, resulting in enormous loads of the central server; 4), as the edge servers will receive more and more requests, each edge server requires to deploy more streaming accordingly, and consequently, the service capability of the edge servers is severely restricted; and 5) if the updating interval of the m3u8 file in the central server is less than the polling interval of the edge servers, a clip loss possibility of the edge servers will be greatly increased.

### SUMMARY

In a first aspect, the present disclosure provide a streaming media file distribution method. The method may include following steps: acquiring an m3u8 file of a streaming media file; determining an edge server which has a subscription service demand for the m3u8 file; and actively distributing the m3u8 file to the edge server.

In a second aspect, the present disclosure provide a streaming media file distribution system. The system includes: at least one processor and a non-transitory storage medium accessible to the at leas one processor. The at least one processor is configured to: acquire an m3u8 file of a streaming media file; determine an edge server which has a subscription service demand for the m3u8 file; and actively distribute the m3u8 file to the edge server.

In a third aspect, the present disclosure provide a non-transitory computer-readable storage medium storing executable instructions. When executed by at least one processor, the executable instructions cause the at least one processor to: acquire an m3u8 file of a streaming media file; determine an edge server which has a subscription service demand for the m3u8 file; and actively distribute the m3u8 file to the edge server.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flow chart of a streaming media file distribution method according to an embodiment of the present disclosure;

FIG. 2 shows a detailed execution chart of one specific implementation mode of step S12 in the method as shown in FIG. 1;

FIG. 3 shows a schematic structural drawing of a streaming media file distribution system according to an embodiment of the present disclosure;

FIG. 4 shows a schematic structural drawing of the streaming media file distribution system according to another embodiment of the present disclosure;

FIG. 5 shows a schematic structural drawing of a streaming media file distribution system according to yet another embodiment of the present disclosure; and

FIG. 6 shows a schematic structural drawing of electronic equipment of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The embodiments of the present disclosure provide a streaming media file distribution method and system to solve at least one of the above-described technical problems in the prior art. By applying the streaming media file distribution method and system provided by the embodiments of the present disclosure, an updated m3u8 file is issued to an edge server in demand. If applied to a central server, the embodiments of the present disclosure have the following beneficial effects compared with a scheme for acquiring the updated m3u8 file via polling among all servers in the prior art.

On the one hand, since edge servers do not need to know an updating time of the m3u8 file in the central server or poll the central server blindly, network bandwidth resources are saved greatly. Field testing results indicate that under a three-layer deployment architecture, namely a “central server-middle server-lower server” deployment architecture, if the updated m3u8 file in the central server is generated after 10s, based on an original server polling scheme, the lower server polls the central server every 2s to acquire three m3u8 files, and fifteen m3u8 files are required to be transmitted within 10s. But in the method provided by the present embodiment, only one m3u8 file is required to be transmitted, so that a bandwidth consumption rate is reduced by (15−1)/15=93% within 10s.

On the other hand, compared with a technical scheme for polling a central server by edge servers in the prior art, the clip loss possibility is eliminated in theory, and the streaming media play experience of users is greatly improved.

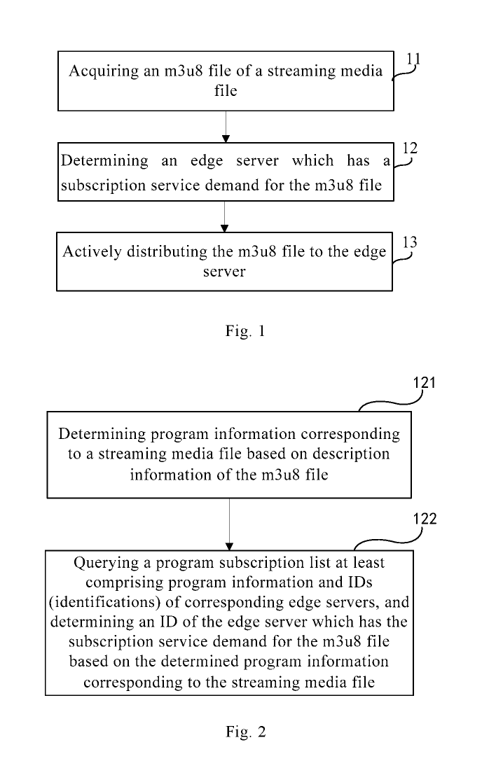

FIG. 1 shows a flow chart of a streaming media file distribution method according to an embodiment of the present disclosure. The method includes:

S11: acquiring by a central server (which is a separate server or server cluster) an m3u8 file of a streaming media file;

S12: determining by the central server an edge server which has a subscription service demand for the m3u8 file; and

S13: actively distributing by the central server the m3u8 file to the edge server.

As a further optimization, after step S13, the method may also include: locally caching by the edge server the updated m3u8 file and a is file corresponding to the m3u8 file on a target edge server based on the received m3u8 file.

By applying the streaming media file distribution method provided by the embodiments of the present disclosure, an updated m3u8 file is issued to an edge server in demand. If applied to a central server, the embodiments of the present disclosure have the following beneficial effects compared with a scheme for acquiring the updated m3u8 file via polling among all servers in the prior art.

On the one hand, since edge servers do not need to know an updating time of the m3u8 file in the central server or poll the central server blindly, network bandwidth resources are saved greatly. Field testing results indicate that under a three-layer deployment architecture, namely a “central server-middle server-lower server” deployment architecture in which the middle server and the lower server correspond to the edge servers in the method provided by the present embodiment, if the updated m3u8 file in the central server is generated after 10s, based on an original server polling scheme, the lower server polls the central server every 2s to acquire three m3u8 files, and fifteen m3u8 files are required to be transmitted within 10s. But in the method provided by the present embodiment, only one m3u8 file is required to be transmitted, so that a bandwidth consumption rate is reduced by (15−1)/15=93% within 10s.

On the other hand, compared with a technical scheme for polling a central server by edge servers in the prior art, the clip loss possibility is eliminated in theory, and the streaming media play experience of users is greatly improved.

As a preferred implementation mode of the present disclosure, acquiring by a central server an m3u8 file of a streaming media file includes generating the m3u8 file of the streaming media file or receiving the m3u8 file of the streaming media file.

Application of the method provided by the present embodiment is not limited to a central server, and the method may be applied to edge servers connected with the above edge server. If the method is applied to any of edge servers, the edge servers may share an updated m3u8 file. Therefore, each edge server can obtain the required updated m3u8 file without subscribing the central server, so that the load of the central server is reduced. For example, under a three-layer deployment architecture, namely a “central server-middle server-lower server” deployment architecture in which the middle server and the lower server correspond to the edge servers in the method provided by the present embodiment, the central server only needs to transmit the updated m3u8 file to the middle server, without transmitting it to the lower server. Thus, the middle and lower servers as the edge servers can share the updated m3u8 file, thereby reducing the load of the central server compared with a scheme that each lower server needs to directly poll a central server in the prior art, and shortening the delay when the lower server acquires the updated m3u8 file.

Referring to FIG. 2, as an optimization of the method shown in FIG. 1, step S12 in FIG. 1 may include the following sub-steps:

S121: determining by a central server program information corresponding to a streaming media file based on description information of an m3u8 file; and

S122: querying by the central server a program subscription list at least including the program information and IDs (identifications) of corresponding edge servers, and determining an ID of the edge server which has the subscription service demand for the m3u8 file based on the determined program information corresponding to the streaming media file.

Application of the method provided by the present embodiment is not limited to a central server, and the method may be applied to edge servers connected with the above edge server. By applying the method, if there are a plurality of edge servers, m3u8 files can be transmitted directionally in a content delivery network.

As a preferred implementation mode of the method provided by the present embodiment, the implementation of step S122 shown in FIG. 2 may include generating a program subscription list by a central server based on a service subscription request of an edge server, wherein the service subscription request at least includes an ID of the edge server and information of a subscribed program.

As an optimization, before generating a program subscription list by a central server based on a service subscription request of an edge server, the method further includes: receiving by the central server the service subscription request from the edge server.

When the method provided by the present embodiment is applied to a content delivery network, an edge server subscribes a corresponding streaming media file from a central server; and afterwards, the central server transmits the streaming media file meeting an edge server subscription request to the edge server, thereby realizing distribution of the m3u8 file according to needs in the content delivery network.

As a preferred implementation mode of the method provided by the present embodiment, the m3u8 file is actively distributed to the edge server in a Transmission Control Protocol (TCP) long connection communication manner.

It should be noted that two independent communication units may be used for receiving a service subscription request sent by an edge server and transmitting an m3u8 file respectively. For instance, if the method provided by the present embodiment is applied to a central server, on the one hand, a long connection communication unit of the central server is dedicated to transmission of the m3u8 file, and a request receiving unit is configured to receive the service subscription request from the edge server. On the other hand, the same communication unit may be used for receiving the service subscription request and transmitting the m3u8 file respectively. For example, the long connection communication unit of the central server may be configured to transmit the m3u8 file as well as receive the service subscription request sent by the edge server.

Application of the method provided by the present embodiment is not limited to a central server, and the method may be applied to other edge servers connected with the above edge server. By applying the method provided by the present embodiment, an updated m3u8 file is issued to an edge server in demand, and the method has the following beneficial effects.

First of all, as the central server establishes a TCP long connection with edge servers below the central server, the central server is able to issue an updated m3u8 file to edge servers in real time, and delay when each edge server updates the m3u8 file is greatly shortened. Field testing results indicate that under a three-layer deployment architecture, namely a “central server-middle server-lower server” deployment architecture in which the middle and lower servers serve as the edge servers in the present embodiment, a theoretical maximum distribution delay when the lower server acquires the m3u8 file changes from 6s to an RTT (Round-Trip Time) which is specifically related to a link between every two servers, of a three-layer TCP connection, an average distribution delay is within 1s, and the communication delay is shortened by 83% or more.

In addition, m3u8 files locally stored in the edge servers are the latest m3u8 files as a central server and the edge servers are communicated in real time in a TCP long connection manner to transmit the m3u8 files. There is no need for each edge server to query the central server after receiving a user access request, so that the load of the central server is greatly reduced. Meanwhile, streaming deployed by each edge server is reduced, an existing socket performance bottleneck is eliminated, and the service capability of the edge servers is significantly enhanced. Field testing results indicate that under a three-layer deployment architecture, namely a “central server-middle server-lower server” deployment architecture, the maximum number of access requests processed by the lower server is increased by 10 times or more.

As a preferred implementation mode of the method provided by the present embodiment, step S122 shown in FIG. 2 further includes: establishing a connection pool associated with a program subscription list based on program information to optimize the query response speed of the program subscription list.

Data connection is one of the important performance indicators influencing the data query efficiency, so the connection pool is put forward for this question. The connection pool is a “buffer pool” for all connections in a database, and is responsible for distribution, management and release of the database connections. It allows an application to reuse an existing database connection, rather than re-establishing one. Database connection missing caused by no database connection release can be avoided by releasing a database connection whose idle time is longer than the maximum idle time. Therefore, the connection pool technology can obviously improve the performance of database operations.

More specifically, in the present embodiment, the central server generates a connection based on program information in a program subscription request, and the connection is kept in the connection pool. As a further optimization, the maximum number of connections in the connection pool is set based on a processing capability of the central server and the number of program subscription information to bring the performance of the connection pool into full play.

By establishing the connection pool to optimize the query response speed of a program subscription list, time for finding a matching edge server is shortened, the occupation of the central server resource during querying the program subscription list is reduced, and moreover, the processing capability of the central server to numerous service subscription requests is improved.

As a preferred implementation mode of the method provided by the present embodiment, the description information of an m3u8 file is a media resource ID.

As a further optimization, program information of a subscribed program may be a type of a media resource ID. When deploying a server content delivery network, streaming media operators can use different edge servers to process streaming media resources corresponding to different types of media resource IDs. For example, if an edge server A in the content delivery network is used for processing variety shows, when it is determined via parsing that a media resource ID (e.g., “Masked Master Singers” or “Super Female Singers”) of a newly generated m3u8 file belongs to variety identifications, the central server issues the newly generated m3u8 file to the edge server A.

As a preferred implementation mode of the method provided by the present embodiment, an edge server adds time offset to an updated m3u8 file, and encapsulates the updated m3u8 file to a live broadcasting m3u8 file satisfying a streaming media protocol. Preferably, the time offset is less than one hour. By applying the method provided by the present embodiment for live broadcasting of streaming media files, the clip loss possibility is eliminated in theory, and the user experience in live broadcasting is greatly improved.

In a specific implementation mode of the present disclosure, a content delivery network is deployed as a three-layer server architecture, namely a “central server-middle server-lower server” architecture, wherein the central server is deployed at a location, such as Beijing, near the streaming media service operators, the middle servers at capital cities, such as Wuhan, Hubei, and the lower servers at prefecture-level cities, such as Xiantao, Hubei. The specific implementation of the streaming media distribution method may include the following steps.

One of the middle servers sends a subscription command to the central server. The central server focuses on corresponding program information based on the subscription command; and meanwhile, said one middle server sends IP information of an edge server to the central server. The central server records a correspondence between the IP information of the edge server and the above program information and stores the correspondence to a service subscription list.

The central server generates a connection including the program information, and keeps the connection in a thread pool. After new m3u8 files are created by an m3u8 creating module, namely an h1s creator or m3u8 builder, of the central server, an m3u8 file corresponding to a clip is file is forwarded in real time to a Receptor module of the central server via a message queue. A TCP long connection dedicated to transmission of the m3u8 files is established between the central server and the middle server.

The Receptor module of the central server uniformly distributes received m3u8 files to a connection pool. The connection pool matches m3u8 keywords with program information in a service subscription list to further send the new m3u8 file to a corresponding middle server in real time via the TCP long connection.

A Packager module of each middle server maintains historical m3u8 information corresponding to each program within one hour, so as to dump the m3u8 information to time offset information and a live broadcasting m3u8 file meeting the h1s protocol.

Further, each middle server distributes the live broadcasting m3u8 file to a lower server corresponding to the middle server in the same way, and it will not be repeated herein.

Field testing results show that a theoretical maximum distribution delay when a lower server acquires an m3u8 file from the central server changes from 6s to an RTT (Round-Trip Time) which is specifically related to a link between every two servers, of a three-layer TCP connection, an average distribution delay is within 1s, and the communication delay is shortened by 83% or more. If an updated m3u8 file in the central server is generated after 10s, based on an original server polling scheme, the lower server polls the central server every 2s to acquire three m3u8 files, and fifteen m3u8 files are required to be transmitted within 10s. But in the method provided by the present embodiment, only one m3u8 file is required to be transmitted, so that a bandwidth consumption rate is reduced by (15−1)/15=93% within 10s. Moreover, the maximum number of access requests processed by each lower server is increased by 10 times or more.

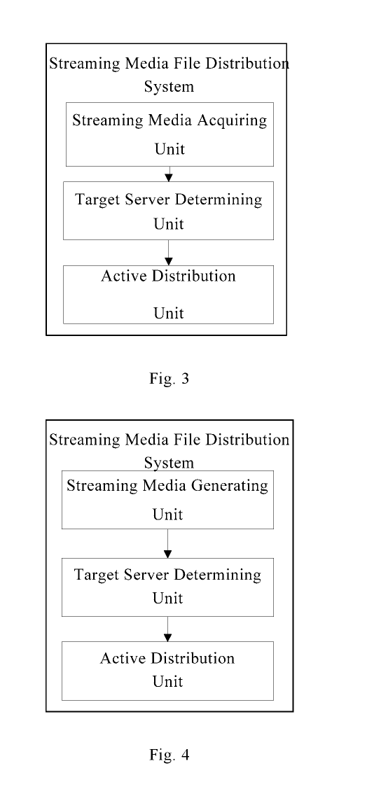

FIG. 3 shows a schematic structural drawing of a streaming media file distribution system according to an embodiment of the present disclosure. The system includes:

a streaming media acquiring unit configured to acquire an m3u8 file of a streaming media file;

a target server determining unit configured to determine an edge server which has a subscription service demand for the m3u8 file acquired by the streaming media acquiring unit; and

an active distribution unit configured to actively distribute the m3u8 file to the edge server determined by the target server determining unit.

By applying the streaming media file distribution system provided by the embodiments of the present disclosure, an updated m3u8 file is issued to an edge server in demand. If applied to a central server, the embodiments of the present disclosure have the following beneficial effects compared with a scheme for acquiring the updated m3u8 file via polling among all servers in the prior art.

On the one hand, since edge servers do not need to know an updating time of the m3u8 file in the central server or poll the central server blindly, network bandwidth resources are saved greatly. Field testing results indicate that under a three-layer deployment architecture, namely a “central server-middle server-lower server” deployment architecture in which the middle server and the lower server correspond to the edge servers in the method provided by the present embodiment, if the updated m3u8 file in the central server is generated after 10s, based on an original server polling scheme, the lower server polls the central server every 2s to acquire three m3u8 files, and fifteen m3u8 files are required to be transmitted within 10s. But in the method provided by the present embodiment, only one m3u8 file is required to be transmitted, so that a bandwidth consumption rate is reduced by (15−1)/15=93% within 10s.

On the other hand, compared with a technical scheme for polling a central server by edge servers in the prior art, the clip loss possibility is eliminated in theory, and the streaming media play experience of users is greatly improved.

In the present embodiment, the streaming media file distribution system may be a separate server or server cluster, and each unit thereof may be a separate server or server cluster. Thus, interaction among the above units is that among the servers or server clusters corresponding to the units, and the plurality of servers or server clusters corresponding to the units together form a streaming media file distribution system provided by the present disclosure.

Particularly, the streaming media file distribution system formed by the servers or server clusters corresponding to all units includes:

a streaming media acquiring server or server cluster configured to acquire an m3u8 file of a streaming media file;

a target server determining server or server cluster configured to determine an edge server which has a subscription service demand for the m3u8 file acquired by the streaming media acquiring server or server cluster; and

an active distribution server or server cluster configured to actively distribute the m3u8 file to the edge server determined by the target server determining server or server cluster.

In one alternative embodiment, several units in the above multiple units together form a server or server cluster. For example, the streaming media acquiring unit constitutes a first server or a first server cluster, and the active distribution unit and the target server determining unit constitute a second server or a second server cluster.

Here, the interaction among the above units is that between the first and second servers or the first and second server clusters, and the first and second servers or the first and second server clusters constitute a scheduling server in the present disclosure.

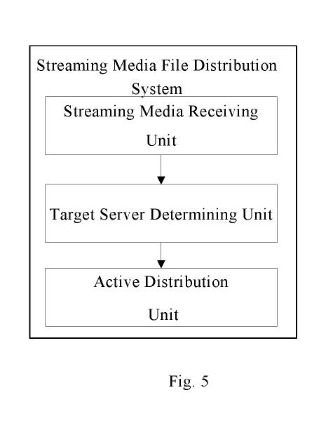

As a preferred implementation mode of the system provided by the present embodiment, referring to FIG. 4, the streaming media acquiring unit in FIG. 3 is a streaming media generating unit for generating an m3u8 file of a streaming media file. As a preferred implementation mode of the system provided by the present embodiment, referring to FIG. 5, the streaming media acquiring unit in FIG. 3 is a streaming media receiving unit for receiving the m3u8 file of the streaming media file.

Application of the system provided by the present embodiment is not limited to a central server including the streaming media generating unit, and the system may be applied to any edge server which includes the streaming media receiving unit and is connected with the above edge server. If the system is applied to any of edge servers, the edge servers may share an updated m3u8 file. Therefore, each edge server can obtain the required updated m3u8 file without subscribing the central server, so that the load of the central server is reduced. For example, under a three-layer deployment architecture, namely a “central server-middle server-lower server” deployment architecture in which the middle server and lower servers correspond to the edge servers in the system provided by the present embodiment, the central server only needs to transmit the updated m3u8 file to the middle server, without transmitting the updated m3u8 file to the lower server. Thus, the middle and lower server as the edge servers can share the updated m3u8 file, thereby reducing the load of the central server compared with a scheme that a lower server needs to directly poll a central server in the prior art, and shortening the delay when the lower server acquires the updated m3u8 file.

As a preferred implementation mode of the system provided by the present embodiment, a target server determining unit is configured to determine program information corresponding to a streaming media file based on description information of an m3u8 file, query a program subscription list at least including the program information and IDs (identifications) of corresponding edge servers, and determine an ID of the edge server which has the subscription service demand for the m3u8 file based on the determined program information corresponding to the streaming media file.

Application of the system provided by the present embodiment is not limited to a central server, and the system may be applied to edge servers connected with the above edge server. By applying the preferred embodiment, if there are a plurality of edge servers, an m3u8 file can be transmitted directionally in a content delivery network.

As a preferred implementation mode of the system provided by the present embodiment, the target server determining unit includes:

a program subscription list generating module configured to generate a program subscription list based on a service subscription request of an edge server, wherein the service subscription request at least includes the ID of the edge server and information of a subscribed program. In the present embodiment, the program subscription list generating module may be a separate server or server cluster.

As a further optimization, the target server determining unit also includes a request receiving module connected with the program subscription list generating module, and configured to receive a service subscription request sent by an edge server. In the present embodiment, the request receiving module may be a separate server or server cluster.

When the system provided by the present embodiment is applied to a content delivery network, an edge server subscribes a corresponding streaming media file from a central server; and afterwards, the central server transmits the streaming media file meeting an edge server subscription request to the edge server, thereby realizing distribution of the m3u8 file according to needs in the content delivery network.

As a preferred implementation mode of the system provided by the present embodiment, the target server determining unit further includes an active distribution unit utilizing a TCP long connection communication manner.

It should be understood that the request receiving module and the active distribution unit may perform communication connection independently. The active distribution unit is dedicated to transmission of an m3u8 file in a TCP long connection manner, and the request receiving module is configured to receive a service subscription request sent from an edge server. In addition, the request receiving module may include the active distribution unit configured to not only receive the service subscription request sent from the edge server but also transmit the m3u8 file in a TCP long connection manner.

Application of the system provided by the present embodiment is not limited to a central server, and the system may be applied to edge servers connected with the above edge server. By applying the system provided by the present embodiment, an updated m3u8 file can be issued to an edge server in demand, and the system has the following beneficial effects.

First of all, as the central server establishes a TCP long connection with an edge server below the central server, the central server is able to issue the updated m3u8 file to the edge server in real time, and delay when the edge server updates the m3u8 file is greatly shortened. Field testing results indicate that under a three-layer deployment architecture, namely a “central server-middle server-lower server” deployment architecture in the middle and lower servers serve as edge servers in the present embodiment, a theoretical maximum distribution delay when each lower server acquires the m3u8 file from the central server changes from 6s to an RTT (Round-Trip Time) which is specifically related to a link between every two servers, of a three-layer TCP connection, an average distribution delay is within 1s, and the communication delay is shortened by 83% or more.

In addition, m3u8 files locally stored in edge servers are the latest m3u8 files as the central server and the edge servers are communicated in real time in a TCP long connection manner to transmit the m3u8 files. There is no need for each edge server to query the central server after receiving a user access request, so that the load of the central server is greatly reduced. Meanwhile, streaming deployed by each edge server is reduced, an existing socket performance bottleneck is eliminated, and the service capability of the edge servers is significantly enhanced. Field testing results indicate that under a three-layer deployment architecture, namely a “central server-middle server-lower server” deployment architecture, the maximum number of access requests processed by each lower server is increased by 10 times or more.

As a preferred implementation mode of the system provided by the present embodiment, the target server determining unit further includes a connection pool established based on program information to optimize the query response speed of the program subscription list.

By establishing the connection pool to optimize the query response speed of a program subscription list, time for finding a matching edge server is shortened, the occupation of the central server resource during querying the program subscription list is reduced, and moreover, the processing capability of the central server to numerous service subscription requests is improved.

As a preferred implementation mode of the system provided by the present embodiment, the description information of an m3u8 file is a media resource ID.

In the embodiments of the present disclosure, related function modules and units can be implemented by a hardware processor.

The embodiments of the present disclosure also provide a non-transitory computer-readable storage medium. One or more programs including execution instructions are stored in the storage medium, and the execution instructions can be read and executable by electronic equipment (including but not limited to a computer, a server, network equipment or the like) for executing related steps in the above method according to the embodiments. The steps include:

acquiring an m3u8 file of a streaming media file;

determining an edge server which has a subscription service demand for the m3u8 file; and

actively distributing the m3u8 file to the edge server.

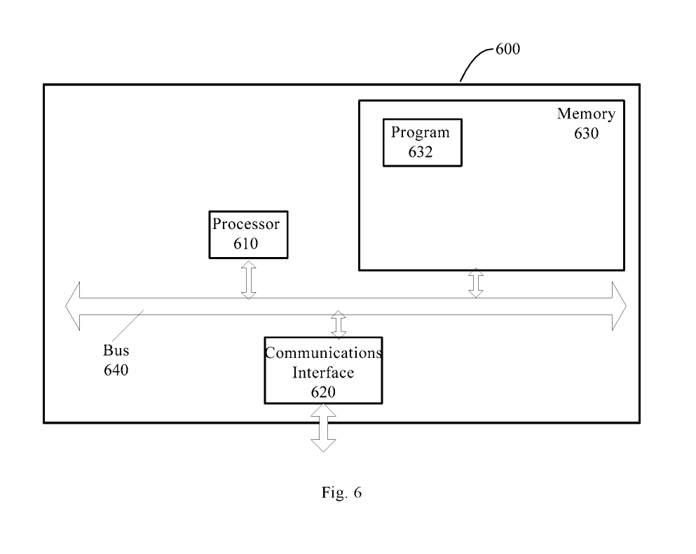

FIG. 6 shows a schematic structural drawing of electronic equipment (including but not limited to a computer, a central server, network equipment or the like) according to an embodiment of the present disclosure. The embodiments of the present application do not limit the specific implementation of the electronic equipment 600. As shown in FIG. 6, the electronic equipment 600 may include:

a processor 610, a communications interface 620, a memory 630 and a communication bus 640.

The processor 610, the communications interface 620 and the memory 630 are communicated with one another via the communication bus 640.

The communications interface 620 is configured to communicate with a network element, such as a client.

The processor 610 is configured to execute a program 632 in the memory 630, and specifically, can execute the related steps in the above method according to the embodiments.

Particularly, the program 632 may include a program code including a computer operation instruction.

The processor 610 may be a central processing unit (CPU), an ASIC (Application Specific Integrated Circuit), or one or more integrated circuits configured to implement the embodiments of the application.

The central server according to the above embodiments includes:

a memory configured to store a computer operation instruction, and a

a processor configured to execute the computer operation instruction stored in the memory so as to:

acquire an m3u8 file of a streaming media file,

determine an edge server which has a subscription service demand for the m3u8 file, and

actively distribute the m3u8 file to the edge server.

In one of application aspects of the present disclosure, the system provided by the embodiments of the present disclosure is suitable for use in a central server and/or edge servers in a content delivery network. Taking streaming media website types and operation directions into consideration, if the system provided by the embodiments of the present disclosure is applied to a streaming media live broadcasting platform or a streaming media rolling broadcasting platform, the response speed in live broadcasting or rolling broadcasting will be accelerated more significantly, and the user experience is optimized.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A method, comprising:
acquiring an m3u8 file of a streaming media file;
determining an edge server which has a subscription service demand for the m3u8 file; and
actively distributing the m3u8 file to the edge server.

2. The method of claim 1, wherein said acquiring an m3u8 file of a streaming media file comprises generating the m3u8 file of the streaming media file or receiving the m3u8 file of the streaming media file.

3. The method of claim 1, wherein said determining an edge server which has a subscription service demand for the m3u8 file comprises:
determining program information corresponding to the streaming media file based on description information of the m3u8 file; and
querying a program subscription list at least comprising the program information and IDs of corresponding edge servers, and determining an ID of the edge server which has the subscription service demand for the m3u8 file based on the determined program information corresponding to the streaming media file.

4. The method of claim 3, wherein the program subscription list is generated based on a service subscription request of the edge server, and the service subscription request comprises the ID of the edge server and information of a subscribed program.

5. The method of claim 1, wherein said actively distributing the m3u8 file to the edge server comprises:
actively distributing the m3u8 file to the edge server in a Transmission Control Protocol (TCP) long connection communication manner.

6. An electronic device, comprising at least one processor and a non-transitory storage medium accessible to the at leas one processor, the at least one processor is configured to:
acquire an m3u8 file of a streaming media file;
determine an edge server which has a subscription service demand for the m3u8 file; and
actively distribute the m3u8 file to the edge server.

7. The electronic device of claim 6, wherein the at least one processor is further configured to:
generate an m3u8 file of the streaming media file or receive the m3u8 file of the streaming media file.

8. The electronic device of claim 6, wherein the at least one processor is further configured to:
determine program information corresponding to the streaming media file based on description information of the m3u8 file, query a program subscription list at least comprising the program information and IDs (identifications) of corresponding edge servers, and determine an ID of the edge server which has the subscription service demand for the m3u8 file based on the determined program information corresponding to the streaming media file.

9. The electronic device of claim 8, wherein the at least one processor is further configured to:
generate a program subscription list based on a service subscription request of the edge server, wherein the service subscription request comprises the ID of the edge server and information of a subscribed program.

10. The electronic device of claim 6, wherein the at least one processor is further configured to adopt a Transmission Control Protocol (TCP) long connection communication manner.

11. A non-transitory computer-readable storage medium storing executable instructions that, when executed by at least one processor, cause the at least one processor to:
acquire an m3u8 file of a streaming media file;
determine an edge server which has a subscription service demand for the m3u8 file; and
actively distribute the m3u8 file to the edge server.

12. The non-transitory computer-readable storage medium of claim 11, wherein the executable instructions further cause the at least one processor to:
generate an m3u8 file of the streaming media file or receive the m3u8 file of the streaming media file.

13. The non-transitory computer-readable storage medium of claim 11, wherein the executable instructions further cause the at least one processor to:
determine program information corresponding to the streaming media file based on description information of the m3u8 file, query a program subscription list at least comprising the program information and IDs (identifications) of corresponding edge servers, and determine an ID of the edge server which has the subscription service demand for the m3u8 file based on the determined program information corresponding to the streaming media file.

14. The non-transitory computer-readable storage medium of claim 13, wherein the executable instructions further cause the at least one processor to:
generate a program subscription list based on a service subscription request of the edge server, wherein the service subscription request comprises the ID of the edge server and information of a subscribed program.

15. The non-transitory computer-readable storage medium of claim 11, wherein the executable instructions further cause the at least one processor to adopt a Transmission Control Protocol (TCP) long connection communication manner.
